(19) United States
(12) Patent Application Publication
(10) Pub. No.: US 2004/0004930 A1
(43) Pub. Date: Jan. 8, 2004

(54) Adjusting device for an optical disk reading device

(76) Inventors: Lih-Hwa Kuo, Taipei (TW); Jeng-Jiun Chen, Taipei (TW); Bor-Ruey Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/324,752

(22) Filed: Dec. 19, 2002

(30) Foreign Application Priority Data
Jul. 5, 2002 (TW) 91210271

(51) Int. Cl. G11B 17/00; G11B 21/16

(52) U.S. Cl. 369/249

(57) ABSTRACT

An optical disk adjusting assembly for an optical disk reading device. The optical disk adjusting assembly includes a chassis, a first guide rod, a second guide rod, an adjustable positioning element, a clamping plate, a disk rotating module and a disk reading module. The first guide rod and the second guide rod are respectively disposed on the chassis. The adjustable positioning element constrains one end of the first guide rod and the second guide rod. The clamping plate is secured to the chassis by screws and used to restrain a portion of the adjustable positioning element. Thus, the adjustable positioning element can constrain and adjust the two guide rods efficiently.

### BACKGROUND OF THE INVENTION

1. Field of the Invention

The invention relates to an optical disk reading device, and more particularly to the optical disk reading device with an adjustable positioning element that can constrain and adjust guide rods efficiently.

2. Description of the Prior Art

Optical disk drives such as CD-ROM drives have been widely used in multimedia computer system, and more particularly for desktop computers. Most computer manufacturers regard the CD-ROM drives as the standard equipment shipped with their product. At present, the reading speed of optical disk drives have increased significantly with the development of optical data storage medium technology. However, the price of every optical disk drive is significantly lowered in recent years. Thus, for disk drives manufacturers, how to reduce the cost of assembly and key components is a challenge.

FIG. 1 shows an optical disk reading assembly 1a of a conventional optical disk reading device.

As shown in FIG. 1, the disk reading assembly 1a is embodied in the conventional CD-ROM drive. The disk reading assembly 1a is provided with a chassis 10a, a disk rotating module 20a, a disk reading module 30a, and two guide rods 40a. The disk reading module 30a is slidably mounted on two guide rods 40a. The two ends of each guide rod 40a must be respectively constrained by two holding pieces 50a fastened by screws 60a on the chassis 10a. If we would like to make sure the optical disk drive can read/write data accurately, then a tilt angle of the disk reading module 30a must be adjusted precisely. In this regard, the disk reading module 30a fails to do read/write operation accurately if the reading module 30a cannot receive the reflective laser beam from the optical disk because of an inaccurate tilt angle. Further, when an assembly worker adjusts the tilt angle of the disk reading module 30a, the assembly worker must fasten the two guide rods 40a by the four screws 60a beforehand. However, until the desirable tilt angle of the disk reading module 30a is determined, the two guide rods 40a are fixedly secured by the four screws 60a. If the assembly worker wants to adjust two guide rods 40a again, he must loose four screws and does the above procedure again. In prior art, the determination of tilt angle of the disk reading module 30a is tedious and time-consuming. Finally, the disk reading module 30a can slide along the guide rods 40a to read the data stored in the CD-ROM optical disk (not shown) that is placed on the disk rotating module 20a after the tilt angle is determined.

The optical disk reading assembly 1a of a conventional, CD-ROM disk drive has the following disadvantages:

1. A plurality of holding pieces 50a are necessary to fasten the ends of two guide rods 40a, which results in increase of manufacturing cost, and

2. The additional holding pieces 50a require more assembly workers to assemble. Even worse, because the holding pieces 50a are thin and light, it is difficult and time-consuming for assembly workers to assemble the holding pieces 50a to the chassis 10a until the tilt angle is determined.

As mentioned, the disadvantages of the conventional optical disk unit must be overcome. Thus, there remains a need for an adjusting device that can constrain and adjust two guide rods with much less manufacturing cycle time and costs.

### SUMMARY OF THE INVENTION

It is an object of the present invention to provide an optical reading with an adjusting device that can constrain and adjust guide rods efficiently.

It is another object of the present invention to provide a disk reading assembly with an adjusting device that can adjust the guide rods with two adjusting screws and resilience of the adjusting device. The present invention requires fewer components, thereby causing cost of manufacture to be decreased and complexity to be reduced.

According to the purposes of the present invention, a disk reading assembly has a chassis, a first guide rod, a second guide rod, an adjustable positioning element, a disk rotating module and a disk reading module. The first guide rod and the second guide rod are respectively disposed on the chassis. One end of both the first guide rod and the second guide rod are fixedly secured to the chassis. The adjustable positioning element constrains the other ends of both the first guide rod and the second guide rod respectively. Therefore, two guide rods can be mounted and adjustable on the chassis by the two adjusting screws and resilience of the adjustable positioning element.

According to the purposes of the present invention, a disk reading assembly has a chassis, a first guide rod, a second guide rod, an adjustable positioning element, a clamping plate, a disk rotating module and a disk reading module. The first guide rod and the second guide rod are respectively disposed on the chassis. One end of both the first guide rod and the second guide rod are fixedly secured to the chassis. The adjustable positioning element constrains the other ends of both the first guide rod and the second guide rod respectively. The clamping plate is used to restrain a portion of the adjustable positioning element on the chassis. Therefore, two guide rods can be mounted and adjustable on the chassis by the two adjusting screws and resilience of the adjustable positioning element.

### DESCRIPTION OF THE DRAWINGS

For a better understanding of the present invention, reference is made to a detailed description to be read in conjunction with the accompanying drawings, in which:

FIG. 1 is a perspective view of a conventional optical disk reading assembly;

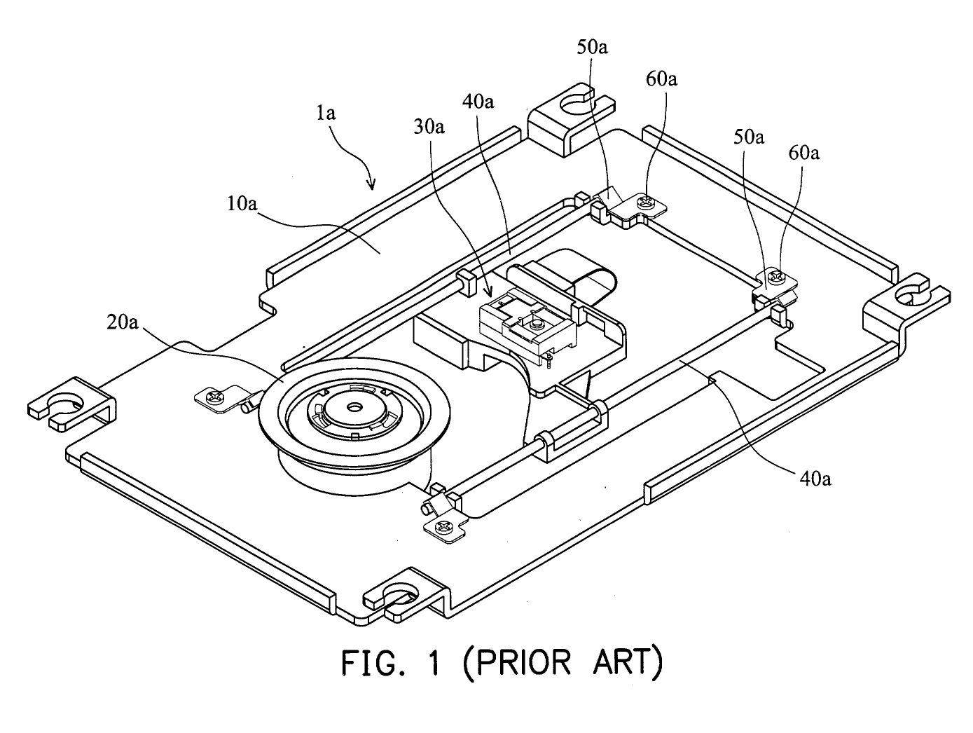

FIG. 2 is an exploded perspective view of the optical disk reading assembly according to the first embodiment of the present invention;

FIG. 3 is a perspective view of the optical disk reading assembly according to the first embodiment of the present invention;

FIG. 4 is a cross-sectional view of the optical disk reading assembly taken along the line A-A of FIG. 3;

FIG. 5 is a partly and enlarged perspective view of the optical disk reading assembly according to the second embodiment of present invention;

FIG. 6 is a partly and enlarged perspective view of the optical disk reading assembly according to the second embodiment of the present invention; and

FIG. 7 is a cross-sectional view of the optical disk reading assembly taken along the line B-B of FIG. 6.

### DETAILED DESCRIPTION OF THE INVENTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Although the principles of the present invention are described below in connection with the CD-ROM disk drive, the present invention can be applied to all optical disk drive, including but not limited to CD drives, DV-DROM/DVD−RAM/DVD-RW drives and combo drives (DVD-ROM+CD-RW), etc.

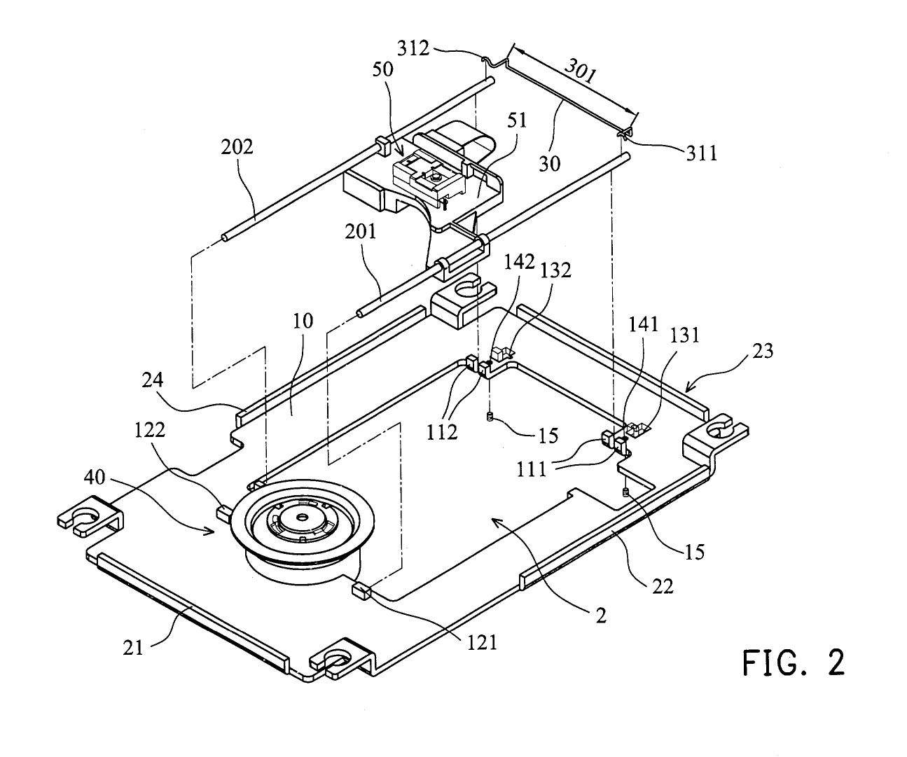

FIGS. 2, 3 and 4 illustrate an optical disk reading assembly 1 according to the first embodiment of the present invention. Also, FIG. 2 best illustrates the interconnections of the various components of the optical disk reading assembly 1.

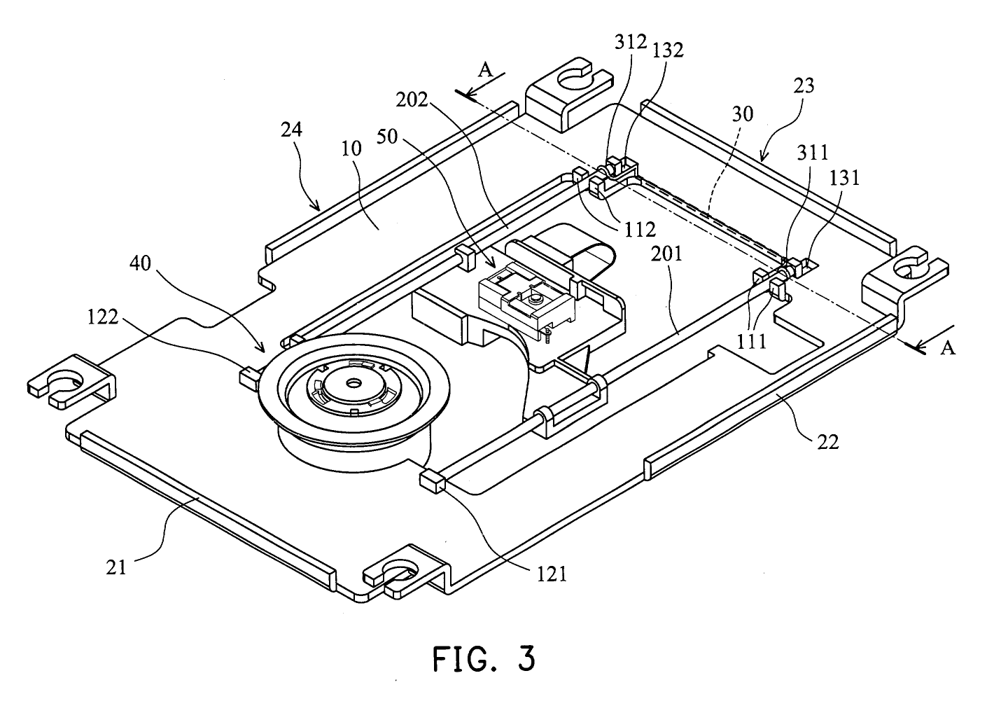

Referring to FIGS. 2 and 3, the optical disk reading assembly 1 according to the present invention has a chassis 10, a first guide rod 201, a second guide rod 202, an adjustable positioning element 30, a disk rotating module 40 and a disk reading module 50. The chassis 10 includes a central hole 2, a front folded sidewall 21, a right folded sidewall 22, a rear folded sidewall 23 and a left folded sidewall 24. The chassis 10 also has a right support 111 positioned near the right sidewall 22 and a left support 112 positioned near the left folded sidewall 24. In addition, the chassis 10 includes two fixing mounts 121, 122 positioned adjacent the disk rotating module 40.

Grooves 131, 132 are also defined on the chassis 10 and near the right support 111 and the left support 112 respectively. Further, screw holes 141 and 142 are also defined on the chassis 10. Screw hole 141 is positioned between the right support 111 and the groove 131, and screw hole 141 is positioned between the left support 112 and the groove 132.

Referring to FIG. 3, the disk reading module 50 is slidably mounted on the first guide rod 201 and the second guide rod 202. One end of the first guide rod 201 is fitted in the fixing mount 121. The right support 111 is adapted to receive the other end of the first guide rod 201. Similarly, one end of the second guide rod 202 is fitted in the fixing mount 122. The left support 112 is adapted to receive the other end of the first guide rod 202.

The adjustable positioning element 30 is of metallic material and has a line segment. Alternatively, the adjustable positioning element 30 also has a plate segment. Further, the adjustable positioning element 30 includes a main constraining portion 301, a first constraining portion 311 and a second constraining portion 312.

To implement the adjustable positioning element 30 to the optical disk reading assembly 1, the adjustable positioning element 30 must be moved to bottom of the chassis 10. The first constraining portion 311 and the second constraining portion 312 of the adjustable positioning element 30 pass through the grooves 131 and 132 respectively. Then, the first constraining portion 311 and the second constraining portion 312 are adapted to contact and constrain the ends of a first guide rod 201 and a second guide rod 202 respectively. In this regard, the adjustable positioning element 30 functions to secure the first guide rod 201 and the second guide rod 202 to the chassis 10 at the same time, as shown in FIG. 3.

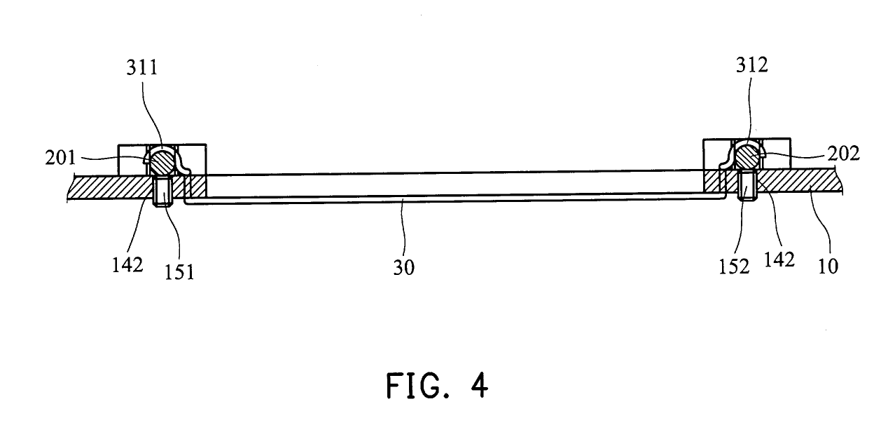

FIG. 4 illustrates the cross-sectional view taken along the line A-A of FIG. 3 and viewed from the rear folded sidewall 23. Referring to FIG. 4, the main constraining portion 301 is pulled against the bottom of the chassis 10 due to the first constraining portion 311 and a second constraining portion 312. The adjusting screws 151 and 152 thread through the screw holes 141 and 142 and are used to adjust the first guide rod 201 and the second guide rod 202. When either adjusting screw 151 or 152 further is threaded into the screw holes 141 or 142, the optical plane defined by the first guide rod 201 and the second guide rod 202 is changed. Once the tilt angle of the disk reading module 50 is determined, the assembly procedure of the optical disk reading assembly 1 is complete.

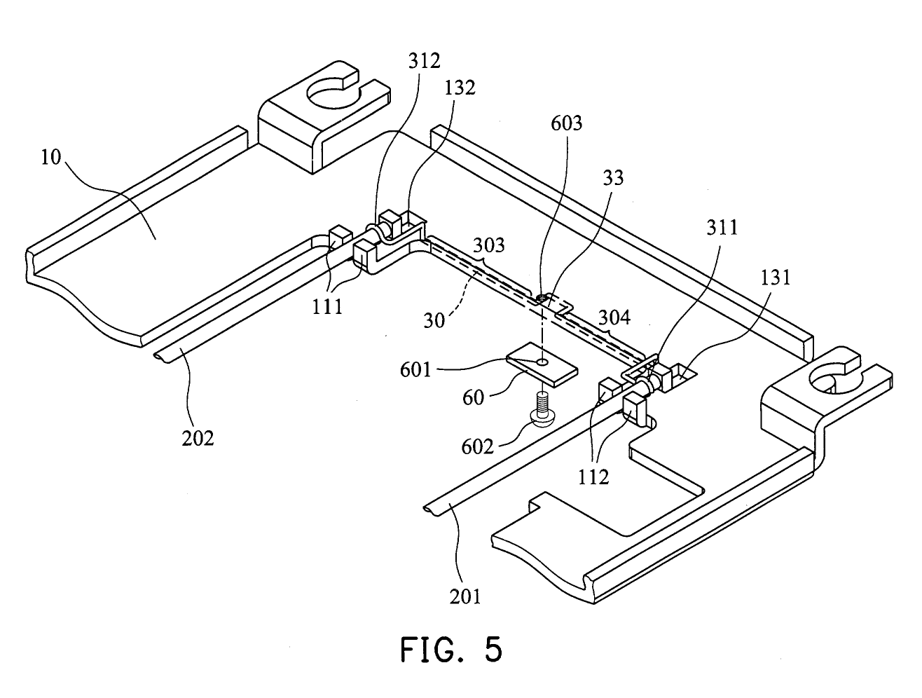

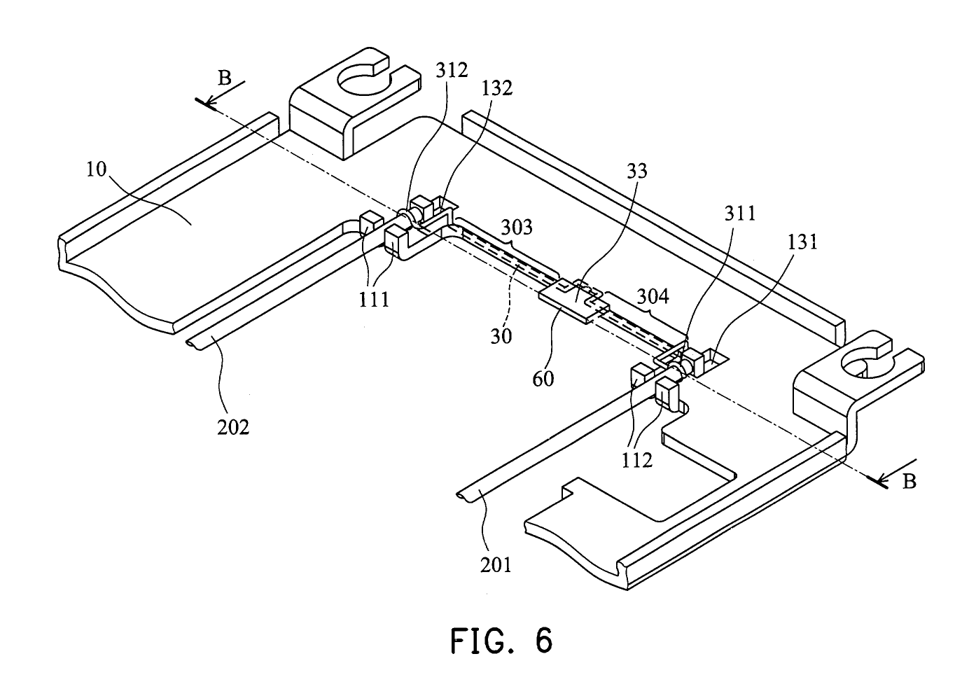

FIG. 5 illustrates the second embodiment of the present invention. Further, FIG. 5 is the cross-sectional view taken along the line B-B of FIG. 6 and also viewed from the rear folded sidewall 23. Referring to FIG. 5, the clamping plate 60 is substantially shaped as a rectangle, and a screw hole 601 is provided thereon. The adjustable positioning element 30 includes line constraining portions 303 and 304, a protruding portion 33, a first constraining portion 311 and a second constraining portion 312.

As described in the first embodiment, to implement the adjustable positioning element 30 to the optical disk reading assembly 1, the adjustable positioning element 30 must be moved to bottom of the chassis 10. The first constraining portion 311 and the second constraining portion 312 of the adjustable positioning element 30 pass through the grooves 131 and 132 respectively. Then, the first constraining portion 311 and the second constraining portion 312 are adapted to contact and constrain the ends of a first guide rod 201 and a second guide rod 202 respectively. In this regard, the adjustable positioning element 30 functions to secure the first guide rod 201 and the second guide rod 202 to the chassis 10 at the same time, as shown in FIG. 5.

Referring to FIG. 5, a screw 602 extends through the holes 601 and 603 to threadly engage with the clamping plate 60 and the chassis 10. In addition, the protruding portion 33 is hooked to the screw 602 so that the adjustable positioning element 30 is prevent from slipping. In this manner, the adjustable positioning element 30 can be tightly fixed on the chassis 10 by the clamping plate 60, as shown in FIG. 6.

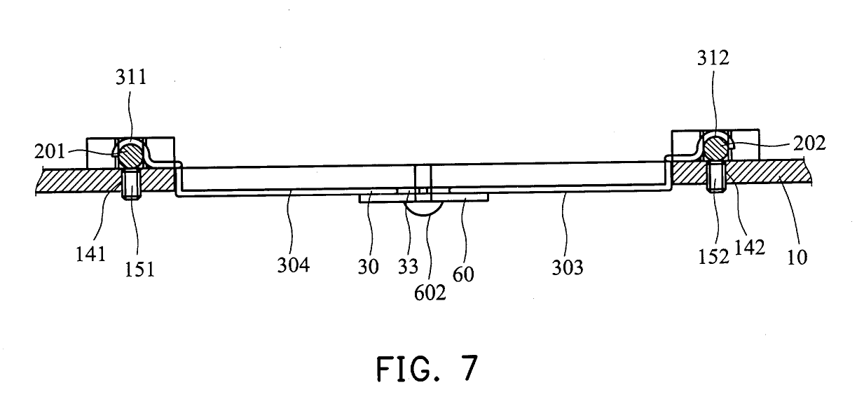

The FIG. 7 illustrates the cross-sectional view taken along the line B-B of FIG. 6 and also viewed from the rear folded sidewall 23. Referring to FIG. 7, the line constraining portions 303 and 304 and the protruding portion 33 of the adjustable positioning element 30 are pulled against the bottom of the chassis 10 due to the first constraining portion 311 and a second constraining portion 312.

When the assembly procedure of the adjustable positioning element 30 is complete, the tilt angle of the disk reading module 50 must be determined. Before the determination of tilt angle begins, the optical disk reading assembly 1 must be placed on a tilt measurement machine (not shown). As described above, adjusting screws 151 and 152 can be adjusted if necessary.

The advantage of the present invention is that the adjustable positioning element 30 constrains the first guide rod 201 and the second guide rod 202. By adjusting two adjusting screws 151 and 152, the tilt angle of the disk reading module 50 can be easily determined. Therefore, the disk reading assembly with the adjustable positioning element that can adjust and constrain the guide rods with two adjusting screws and resilience of the adjustable positioning element.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adjusting device for an optical disk reading device, comprising:
a chassis having a plurality of supports and grooves;
a first guide rod and a second rod, each rod having two ends disposed on two supports;
a disk reading module, being sildably mounted on the first guide rod and the second guide rod;
an adjustable positioning element, passing through the grooves of the chassis and constraining the one end of the first guide rod and the second guide rod; and
a disk rotating module, fixed to the chassis and used to rotating optical disk.

2. The adjusting device as claimed in claim 1, wherein the adjustable positioning element further includes a plurality of constraining portions to restrict the one end of the first guide rod and the second guide rod.

3. The adjusting device as claimed in claim 1, wherein the adjustable positioning element includes line segment or plate-shaped segments.

4. The adjusting device as claimed in claim 1, wherein the adjustable positioning element is of elastic material.

5. An adjusting device for an optical disk reading device, comprising:
a chassis having a plurality of supports and grooves;
a first guide rod and a second rod, each rod having two ends disposed on two supports;
a disk reading module, being sildably mounted on the first guide rod and the second guide rod;
an adjustable positioning element, passing through the grooves of the chassis and constraining the one end of the first guide rod and the second guide rod;
a disk rotating module, fixed to the chassis and used to rotating optical disk; and
a clamping plate, threadly engaging with the chassis by fixed to the chassis by a screw and constraining a portion of the adjustable positioning element.
